(19) United States
(12) Patent Application Publication
(10) Pub. No.: US 2006/0213786 A1
(43) Pub. Date: Sep. 28, 2006

(54) Trash receptacle

(76) Inventor: Ron C. Walser, Tampa, FL (US)

Correspondence Address: LITMAN LAW OFFICES, LTD, PO BOX 15035, CRYSTAL CITY STATION, ARLINGTON, VA, 22215, US

(21) Appl. No.: 11/090,219

(22) Filed: Mar. 28, 2005

(51) Int. Cl. A47G 7/00; A01G 9/02; B65D 77/00; B65D 85/50

(52) U.S. Cl. 206/216; 47/66.6; 206/423; 47/41.11

(57) ABSTRACT

The trash receptacle is a generally frustoconical container and removable lid that simulate an outdoor planter or the like to provide an aesthetically pleasing receptacle for holding bagged or loose trash. The sidewalls of the container taper inwardly from the top to the bottom of the container. A plurality of L-shaped angle brackets are radially mounted on the interior sidewalls near the top of the container. The brackets support the removable lid. The lid has a handle for grasping that is mounted in the center of the lid and a plurality of circular apertures in the lid radially disposed around the handle. The circular apertures are designed to receive bunched stalks of artificial greenery to create the appearance of a potted plant and the like.

### BACKGROUND OF THE INVENTION

1. Field of the Invention

The present invention relates to trash receptacles, and more particularly to a trash receptacle having a lid supporting artificial plants disposed on a container, which may have the appearance of a flower pot, adapted for holding household trash and the like in an inconspicuous and aesthetically pleasing manner.

2. Description of the Related Art

Residential dwellers and the like typically deposit their bagged and loose garbage into trash receptacles, such as garbage cans, that are normally kept outside the dwelling. These garbage cans are usually plastic or metal cylindrical containers that have an unattractive and unsightly quality, which prompts many people to place them out of the view of the general public. However, it is often necessary to place the unsightly garbage cans in front of a dwelling for periodic collection of the contents by municipal or private entities.

A similar problem arises in apartment or multi-family residential buildings, or commercial office buildings, that provide trash pickup services for trash that is bagged, tied, and left in a trash can in the hallway outside the door of the dwelling or office. Conventional garbage cans or trash cans leave a poor impression of the sanitation of the residential or commercial facility.

Although various trash receptacles have been designed with a planter disposed on top of the receptacle, such receptacles are often still unsightly or difficult to use, being equipped with sliding lids and the like. Thus, a trash receptacle solving the aforementioned problems is desired.

### SUMMARY OF THE INVENTION

The trash receptacle of the present invention has a generally frustoconical container and a removable lid that simulate an outdoor planter or the like to provide an aesthetically pleasing receptacle for holding bagged or loose trash. The sidewalls of the container taper inwardly from the top to the bottom of the container. A plurality of L-shaped brackets are radially mounted on the interior sidewalls near the top of the container. The brackets support the removable lid to cover the open top of the container. The lid has a handle for grasping that is mounted in the center of the lid and a plurality of circular apertures in the lid radially disposed around the handle. The circular apertures receive artificial greenery to create the appearance of a potted plant and the like.

These and other features of the present invention will become readily apparent upon further review of the following specification and drawings.

### BRIEF DESCRIPTION OF THE DRAWINGS

FIG. 1 is an environmental, perspective view of a trash receptacle according to the present invention.

FIG. 2 is a partially exploded view of the trash receptacle according to the present invention.

FIG. 3 is a top plan view of the container of the trash receptacle according to the present invention.

FIG. 4 is a diagrammatic, exploded section view of the trash receptacle according to the present invention.

FIG. 5 is a fragmentary perspective view of the lid of the trash receptacle according to the present invention.

Similar reference characters denote corresponding features consistently throughout the attached drawings.

### DETAILED DESCRIPTION OF THE PREFERRED EMBODIMENTS

The present invention is a trash receptacle, designated generally as 10 in the drawings, that holds bagged or loose trash therein in an aesthetically pleasing manner. The trash receptacle 10 includes a generally frustoconical container, a plurality of support brackets, and a removable lid that supports artificial greenery.

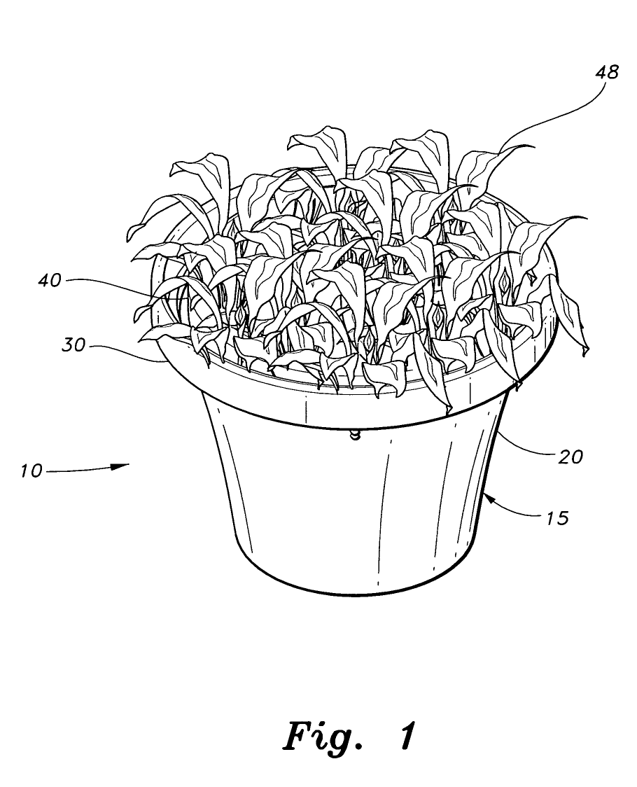

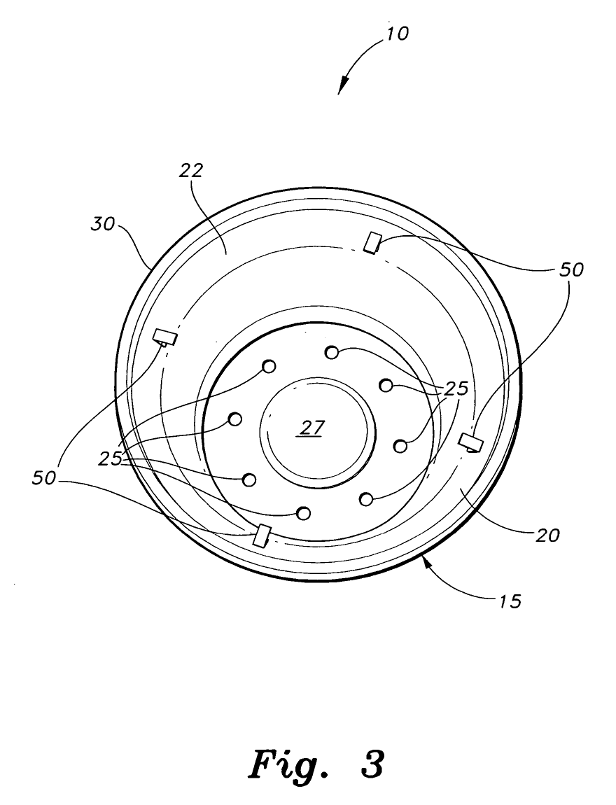

Referring to FIGS. 1-3, the container 15 has a generally frustoconical configuration, having sidewalls 20 that taper inwardly from top to the bottom of the container 15. An integral rim 30 spans the entire upper periphery of the container 15 and overhangs or protrudes from the wall of the container 15 to facilitate grasping and moving the container 15. The bottom of the container 15 may have a raised central portion 27 around which a plurality of circular apertures 25 are radially disposed in the bottom wall of the container 15. Alternatively, the bottom of the container 15 can be made without the raised central portion 27 and circular apertures 25.

The container 15 can be formed from ceramic, metallic, clay, plastic, or other structural material. The preferred embodiment is made from molded plastic in the form of a large planter. The container 15 may be made in any desired size, but has a volume sufficient to receive bags of trash waiting for pickup and disposal.

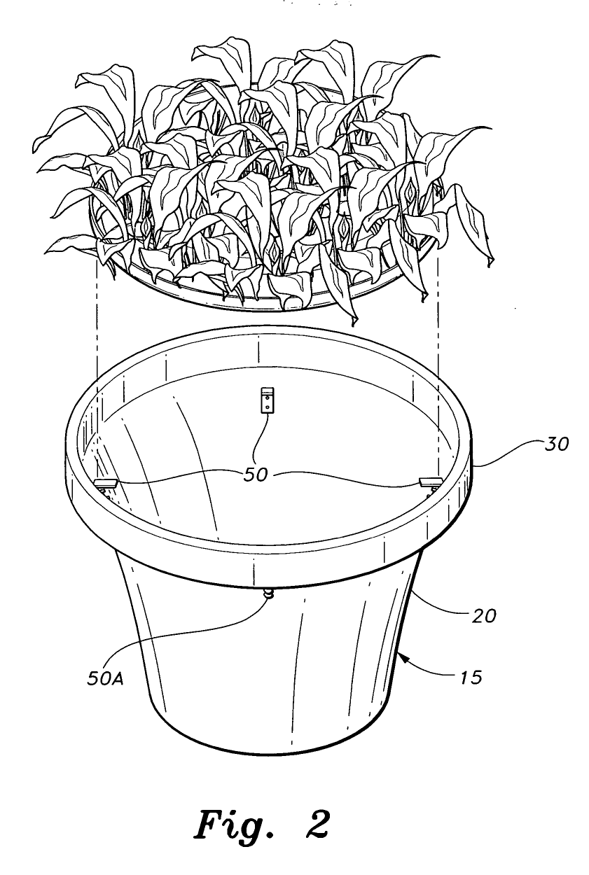

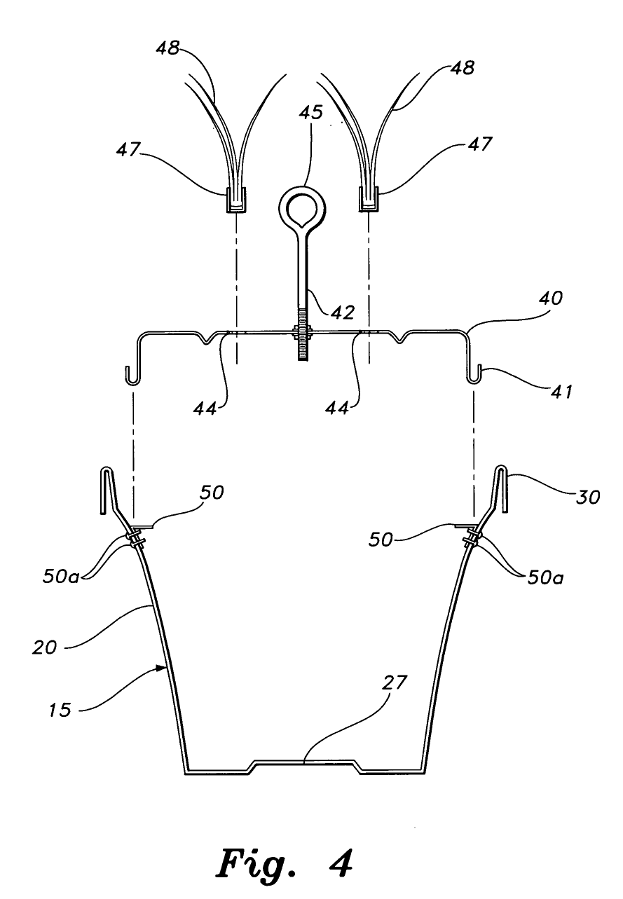

Referring to FIGS. 2-4, a plurality of support brackets 50 are radially disposed on the interior sidewalls 20 near the upper periphery of the container 15. The support brackets 50 are L-shaped angles having one leg with apertures defined therein to facilitate mechanically fastening the bracket 50 to the container 15. The mechanical fasteners 50a may be a nut and a bolt or any other fasteners that will hold the brackets rigidly to the container 15.

The support brackets 50 and mechanical fasteners can be made from any suitable material, such as metal or plastic. Any suitable means, such as rivets, may be used to securely fasten the support brackets 50 to the container.

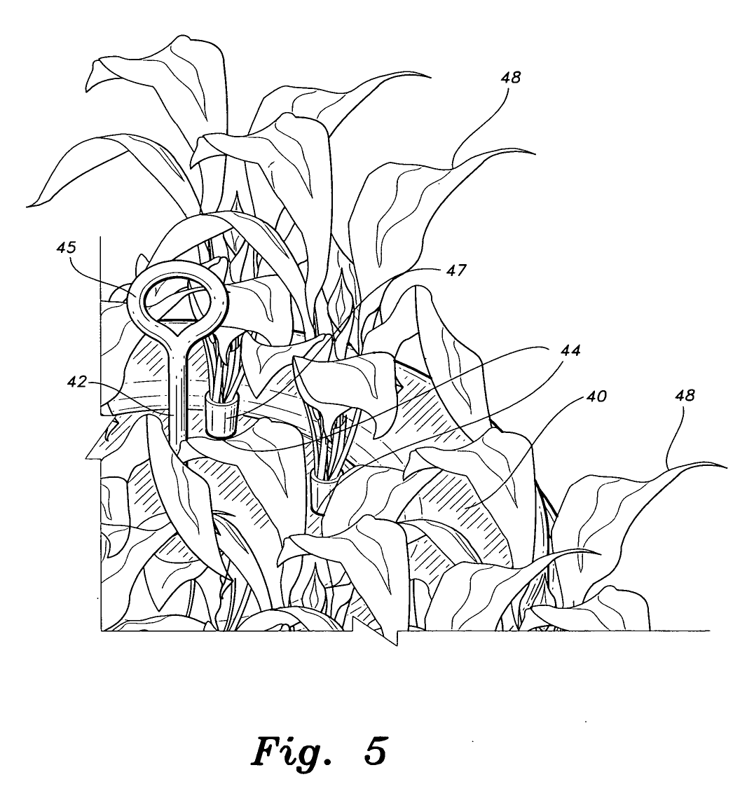

Referring to FIGS. 2-5, the removable lid 40 is a circular plate with a depending peripheral sidewall having a lip 41 that curves and projects upwardly from the bottom of the sidewall of the lid 40. The lid 40 is received within the opening of the container 15 and rests upon the support brackets 50 recessed below the opening and flush with the upper periphery of the container 15. A handle 42 is mounted in the middle of the lid 40 to facilitate removing and replacing the lid 40. The handle 42 may be an eyebolt that is mechanically fastened to the lid 40 and has a ring portion 45 that is grasped by the user. A plurality of circular apertures 44 in the lid is radially disposed around the handle 42. The circular apertures 44 receive cylindrical fittings 47 that contain the distal ends of bunched stalks of artificial greenery 48. As seen in FIG. 1, the artificial greenery 48 is abundant enough to generally conceal the lid 40 and handle 42 from view and provide an aesthetically pleasing appearance in conjunction with the container 15.

The lid 40 and handle 42 can be formed from ceramic, metallic, plastic, or other rigid materials. If desired, the handle 42 may include a flexible rope or cord attached to the handle 42 that can be grasped by the user to remove the lid 40. Artificial ivy is the preferred greenery 48, but various types of artificial plants can be used to provide an aesthetic appearance in conjunction with the container 15.

It will be understood that the container 15 is not limited to a frustoconical shape and the lid 40 is not limited to a circular shape, the present invention extending to a container of any shape and a lid shaped to cover the opening defined by the container, the lid having a handle for lifting the lid from the container and a plurality of artificial plates disposed on the top of the lid. The flowerpot shape shown in the drawings, however, does have a universally pleasing aesthetic appearance suitable for use on either the exterior of a building, in the interior of a multi-family residential building, or a commercial building.

It is to be understood that the present invention is not limited to the embodiments described above, but encompasses any and all embodiments within the scope of the following claims.

I claim:

1. A trash receptacle, comprising:
a container having a bottom wall defining a periphery and at least one sidewall extending about the periphery of the bottom wall and defining a top opening, the container having a volume adapted for receiving a trash bag awaiting pickup and disposal;
a plurality of brackets mounted to the sidewall adjacent the top opening;
a lid dimensioned and configured to cover the top opening of the container, the lid being removably supported on the brackets and having a top surface;
a handle attached to and arising from the lid; and
a plurality of artificial plants attached to the top surface of the lid;
wherein the lid is lifted from and set back down on the brackets in order to place the trash bag in, and remove the trash bag from, the container, the artificial plants providing an aesthetically pleasing appearance.

2. The trash receptacle according to claim 1, wherein the bottom wall of said container has a raised center portion and a plurality of circular apertures radially disposed in the bottom wall of said container around the center portion.

3. The trash receptacle according to claim 1, wherein said handle comprises an eyebolt.

4. The trash receptacle according to claim 3, further comprising an elongate, flexible member attached to the eyebolt for facilitating lifting of said lid.

5. The trash receptacle according to claim 1, container is frustoconical in shape.

6. The trash receptacle according to claim 5, wherein said lid is circular in shape, the container and lid simulating a flower pot and planter in appearance.

7. The trash receptacle according to claim 5, wherein said container further comprises a rim projecting from the sidewall about the top opening.

8. The trash receptacle according to claim 1, wherein said brackets are L-shaped brackets attached to said sidewall.

9. The trash receptacle according to claim 1, further comprising a plurality of cylindrical fittings radially disposed through said lid, said artificial plants being supported in the cylindrical fittings.

10. A trash receptacle, comprising:
a container having a bottom wall defining a periphery and at least one sidewall extending about the periphery of the bottom wall and defining a top opening, the sidewall having a frustoconical shape, the container having a volume adapted for receiving a trash bag awaiting pickup and disposal;
a plurality of L-shaped brackets mounted to the sidewall adjacent the top opening;
a circular lid having a peripheral sidewall depending therefrom, the lid being dimensioned and configured to cover the top opening of the container, the lid being removably supported on the brackets and having a top surface;
a handle attached to and arising from the lid; and
a plurality of artificial plants attached to the top surface of the lid;
wherein the lid is lifted from and set back down on the brackets in order to place the trash bag in, and remove the trash bag from, the container, the artificial plants providing an aesthetically pleasing appearance.

11. The trash receptacle according to claim 10, wherein said handle comprises an eyebolt.
